(19) United States
(12) Patent Application Publication
(10) Pub. No.: US 2013/0308082 A1
(43) Pub. Date: Nov. 21, 2013

(54) Liquid Crystal Display Panel

(71) Applicants: Ming Liu, Shenzhen (CN); Tao Song, Shenzhen (CN); Tao Ma, Shenzhen (CN); Guodong Zhao, Shenzhen (CN)

(72) Inventors: Ming Liu, Shenzhen (CN); Tao Song, Shenzhen (CN); Tao Ma, Shenzhen (CN); Guodong Zhao, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/697,010

(22) PCT Filed: Aug. 3, 2012
(86) PCT No.: PCT/CN2012/079648

§ 371 Date: Nov. 9, 2012

(30) Foreign Application Priority Data
May 17, 2012 (CN) 201210154083.0

(51) Int. Cl. G02F 1/1339

(52) U.S. Cl. CPC G02F 1/1339
USPC 349/153

(57) ABSTRACT

The present invention discloses an LCD panel. The LCD panel includes a first substrate and a second substrate, arranging with the first substrate in pair, a glue, between the first substrate and the second substrate, for pasting the first substrate and the second substrate. A plurality of grooves arrange at intervals on at least one of two adjacent surfaces on the first substrate and the second substrate, and part of the glue, set up on the grooves, permeates the grooves. the LCD panel in the present invention reduces width of the glue effectively to achieve the design of narrow bezel of the LCD panel by arranging a groove structure in a glue coating area on the substrate surface to increase a contact area between the glue and tie substrate in an adhesion force assurance between the glue and a substrate.

### BACKGROUND OF THE INVENTION

1. Field of the Invention

The present invention relates to a liquid crystal display (LCD) field, more particularly, to an LCD panel.

2. Description of the Prior Art

With the endless development of LCD technologies, an LCD panel has been broadly applied to various electrical devices. Designers for the electrical devices devote themselves to reducing product volumes to meet the demands for consumers and markets. Under the circumstance of reduction in volumes of electrical products, however, there is still another appetite for larger display sizes. Therefore, there is a trend for display panel products with larger display sizes but smaller volumes.

TFT substrates and CF substrates in TFT-LCD products are mainly pasted through a glue so that the closed space for putting liquid crystals and alignment films is formed between the TFT substrates and the CF substrates. The widths of glues in the prior art are different according to product sizes, and most widths are around a thousand micro-meters. Markets and consumers regard favor with the narrow bezel which means that the narrower of the width from display area to the edge of glass is, the more popular it is. But it occurs many problems like weak adhesion force of the glue with the substrate and penetration from outside air if it simply adopts reduction in the width of the glue to achieve the narrow bezel.

For that reason, it is necessary to provide an LCD panel to solve the problem of an LCD panel with wider flame in the prior art.

### SUMMARY OF THE INVENTION

The present invention provides an LCD panel that assures adhesion using between a glue and a substrate while reducing width of the glue effectively.

According to the present invention, an LCD panel comprises: a first substrate; a second substrate, opposite to the first substrate; a glue between the first substrate and the second substrate, for sticking the first substrate to the second substrate. A plurality of grooves arrange at intervals on at least one of two adjacent surfaces on the first substrate and the second substrate, and part of the glue set up on the grooves, permeates the grooves.

In one aspect of the present invention, the glue spreads toward a first direction and a second direction perpendicular to the first direction, length of the glue in the first direction is longer than that of the glue in the second direction, and the grooves are arranged along with the first direction at intervals and extend along with the second direction.

In another aspect of the present invention, the grooves are disposed on both of the two adjacent surfaces.

In another aspect of the present invention, the first substrate comprises a first substrate body and a first surface layer on the first substrate body, the second substrate comprises a second substrate body and a second surface layer on the second substrate body, the first surface layer is set up with the second surface layer adjacently, and the grooves are arranged on the first surface layer and the second surface layer.

In another aspect of the present invention, depth of the grooves is equal to thickness of the first surface layer or that of the second surface layer.

In another aspect of the present invention, the first surface layer and the second surface layer comprise a transparent conductive layer.

In another aspect of the present invention, the LCD panel further comprises a conductive pad, locating m an area where the glue is, for electrically connecting the first substrate with the second substrate, and distance between centers of the two adjacent grooves is shorter than half of the interval distance between the conductive pad and the grooves.

In another aspect of the present invention, the distance is shorter or equal to 700 micrometers.

In another aspect of the present invention, a width of the grooves is longer or equal to 5 micrometers.

In another aspect of the present invention, a cross section of the grooves in the interval direction is isosceles trapezoid.

According to the present invention an LCD panel comprises: a first substrate; a second substrate, opposite to the first substrate; a glue between the first substrate and the second substrate, for sticking the first substrate to the second substrate, the glue spreading toward a first direction and a second direction perpendicular to the first direction, length of the glue in the first direction being It tiger than that of the glue in the second direction. A plurality of grooves are arranged at intervals on two adjacent surfaces on the first substrate and the second substrate, the grooves are arranged along with the first direction at intervals and extend along with the second direction, and part of the glue, set up on the grooves, permeates the grooves.

In one aspect of the present invention, the first substrate comprises a first substrate body and a first surface layer on the first substrate body, the second substrate comprises a second substrate body and a second surface layer on the second substrate body, the first surface layer is set up with the second surface layer adjacently, and the grooves are to arranged on the first surface layer and the second surface layer.

In another aspect of the present invention, depth of the groove is equal to thickness of the first surface layer or that of the second surface layer.

In another aspect of the present invention, the first surface layer and the second surface layer comprise a transparent conductive layer.

In another aspect of the present invention, the LCD panel further comprises a conductive pad, locating in an area where the glue is, for electrically connecting the first substrate with the second substrate, and a distance between centers of the two adjacent grooves is shorter than half of the interval distance between the conductive pad and the grooves.

In another aspect of the present invention, the distance is shorter or equal to 700 micrometers.

In another aspect of the present invention, a width o the grooves is longer or equal to 5 micrometers.

In another aspect of the present invention, a cross section of the grooves in the interval direction is isosceles trapezoid.

According to the present invention, an LCD panel comprises: a first substrate comprising a first substrate body and a first surface layer on the first substrate body; a second substrate, opposite to the first substrate, the second substrate comprising a second substrate body and a second surface layer on the second substrate body; a glue between the first substrate and the second substrate, for sticking the first substrate to the second substrate. The first surface layer is set up with the second surface layer adjacently, a plurality of grooves arrange at intervals on at least one of two adjacent surfaces on the first substrate and the second substrate, and part Of the glue, set up on the grooves, permeates the grooves.

In one aspect of the present invention, the glue spreads toward a first direction and a second direction perpendicular to the first direction, length of the glue in the first direction is longer than that of the glue in the second direction, and the grooves are arranged along with the first direction at intervals and extend along with the second direction.

The benefit of the present invention is that the LCD panel in the present invention reduces width of the glue effectively to achieve the design of narrow bezel of the LCD panel by arranging a groove structure in a glue coating area on the substrate surface to increase a contact area between the glue and the substrate in an to adhesion force assurance between the glue and a substrate.

### BRIEF DESCRIPTION OF THE DRAWINGS

These and other objectives of the present invention will no doubt become obvious to those of ordinary skill in the art after reading the following detailed description of the preferred embodiment that is illustrated in the various figures and drawings.

FIG. 1 shows a cross-sectional view of an LCD panel according to an embodiment of the present invention.

FIG. 2 is a cross-sectional view of the LCD panel along an A-A′ line in FIG. 1.

FIG. 3 illustrates a top view of the second substrate of the LCD panel according to the embodiment of the present invention.

FIG. 4 shows an enlarged cross-sectional view of the grooves in the LCD panel in FIG. 2.

### DETAILED DESCRIPTION OF THE PREFERRED EMBODIMENTS

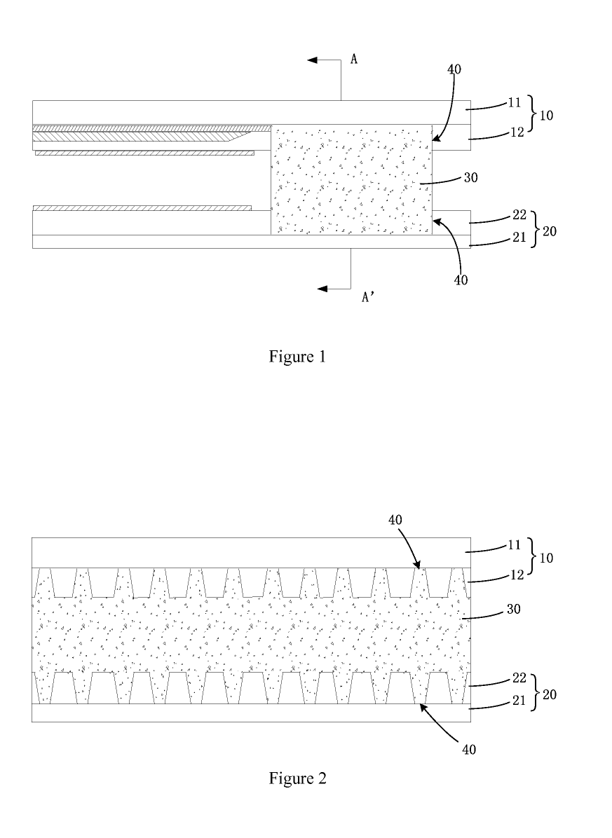

The following is a detailed description of the preferred embodiment of the invention. Referring to FIG. 1 and FIG. 2, FIG. 1 shows a cross-sectional view of an LCD panel according to an embodiment of the present invention, and FIG. 2 is a cross-sectional view of the LCD panel along an A-A′ line in FIG. 1. As FIG. 1 and FIG. 2 shows, the LCD panel comprises a first substrate 10, a second substrate 20 and a glue 30.

The first substrate 10 and the second substrate 20 are arranged in opposite sides. The first substrate 10 comprises a first substrate body 11 and a first surface layer 12 on the first substrate body 11. The second substrate 20 comprises a second substrate body 21 and a second surface layer 22 on the first substrate body 21. The first surface layer 12 is adjacent to the second surface layer 22.

The first substrate body 11 and the second substrate body 21 of the embodiment are respectively glass substrate. The first surface layer 12 and the second surface layer 22 respectively comprise a transparent conducting layer (such as ITO layer), and there is no more description because the detailed manufacture and substance are acquired in the present technology. Without a doubt the first surface layer 12 and the second surface layer 22 of other embodiments are capable of comprising other functional layers or not as well.

The glue 30 is arranged to stick the first substrate 10 to the second substrate 20.

The two adjacent surfaces of the first substrate 10 and the second substrate 20 arrange a plurality of grooves 40 at intervals. Each groove 40 is formed in the coating area of the glue 30 at intervals by an etching process or other appropriate processes in a forming process of the first surface layer 12 on the first substrate 10 and the second surface layer 22 on the second substrate 20. In hence, The grooves 40 are set up on the first surface layer 12 and the second surface layer 22 at intervals, and the depth of the grooves 40 is preferably equal to the thickness of the first surface layer 12 or that of the second surface layer 22. The preferred depth range of the grooves 40 of the embodiment is from 0.4 micrometers to 1.6 micrometers. The grooves 40 of other embodiments are able to just set up on one of the first substrate 10 and the second substrate 20 and are formed on other functional layers on the surface of the first substrate 10 and the second substrate 20 or on the first substrate body 11 and the second substrate body 21 directly as well. The depth of the grooves 40 is adjustable if it is in need.

The glue 30 set up on the grooves 40 covers the grooves 40, and part of the glue 30 permeates the grooves 40 through the above-mentioned methods so that it increases the contact area among the glue 30, the first substrate 10 and the second substrate 20. Therefore, the design of narrow bezel of the LCD panel is achieved by the effective reduction in width of the glue in the condition of an adhesion force assurance between the glue and the substrate.

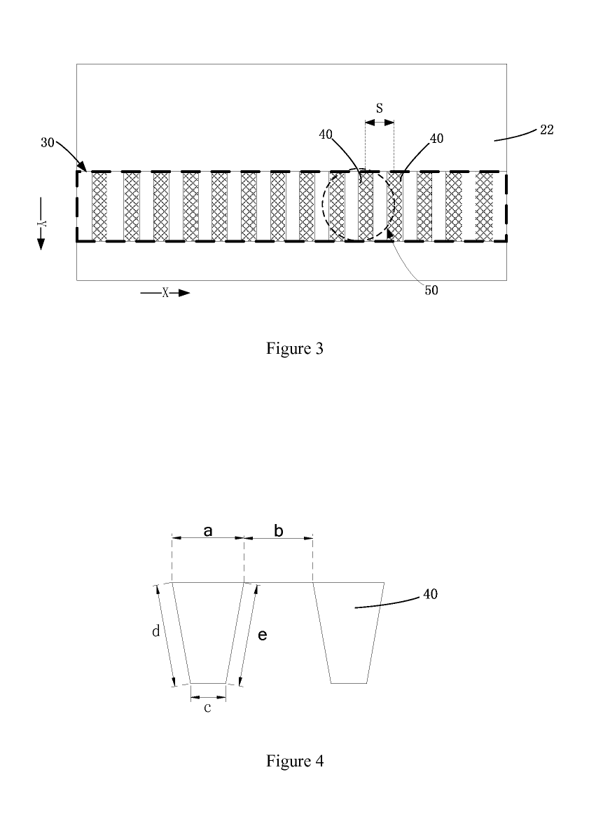

Please refer to FIG. 3. FIG. 3 illustrates a top view of the second substrate of the LCD panel according to the embodiment Of the present invention. The specific arrangement of the grooves 40 in the second substrate 20 is described following. The glue 30 spreads toward a first direction X and a second direction Y perpendicular to the first direction X, and. A plurality of grooves 40 are set up along with the length-direction X of the glue 30 at intervals and extend along with the width-direction Y. There are also other arrangements for interval and extension directions of the grooves 40 of other embodiments.

Furthermore, the number of distance S between centers of two adjacent grooves 40 is changeable if in need. Generally speaking, the LCD panel further comprises a conductive pad 50 in the area where the glue 30 locates for electrically connecting with the first substrate 10 and the second substrate 20 to make the first substrate 10 and the second substrate 20 contact the floor at the same time. To assure excellent conduction of the conductive pad 50, the distance S between centers of two adjacent grooves 40 is preferred to be less or equal to half of the interval distance between the conductive pad 50 and the grooves 40. The diameters of the conductive pad 50 is ordinarily around 1400 micrometers so that the distance S is preferred to be shorter or equal to 700 micrometers. in the meantime, to ensure exposure accuracy. the preferred width of the grooves 40 is longer or equal to 5 micrometers.

Referring to FIG. 4, FIG. 4 shows an enlarged cross-sectional view of the grooves in the LCD panel in FIG. 2. A cross section of the grooves 40 in the interval direction is isosceles trapezoid according to the surface film formation principle (the exposure principle). According to the calculation, the ratio of increased contact measure of the glue 30 to a substrate (the first substrate 10 or the second substrate 20) using the grooves 40 structure is:

[(c+d+e+b)−(a+b)]/(a+b)=(c+d+e−b)/(a+b) that

a is the width of the upper border of the grooves 40;

b is the distance between the two adjacent grooves 40, and a+b=S;

c is the width of the lower border of the grooves 40;

d and e represent the side length of the grooves 40 which approximately equals the depth of the grooves 40.

Compared with a substrate without the grooves 40, the increased contact measure between the glue 30 and a substrate surface is around 1.5×2/5=60% in the condition that S equals 5 micrometers and both d and e equal 1.5 micrometers. That is to say the increased contact surface measure among the glue 30, the first substrate 10 and the second substrate 20 is 120% if both the first substrate 10 and the second substrate 20 comprise the grooves 40. The increased contact measure between the glue 30 and a substrate surface is around 1.5×2/700=0.43% in the condition that S equals 700 micrometers. And the increased contact surface measure among the glue 30, the first substrate 10 and the second substrate 20 is 0.86% if both the first substrate 10 and the second substrate 20 comprise the grooves 40. Therefore, the increased contact surface measure in the grooves 40 structure in the present invention among the glue 30, the first substrate 10 and the second substrate 20 is from 0.86% to 120%. The design of narrow bezel is achieved by the reduction in the glue 30 in the present invention because of the increased contact measure that ensures the adhesion force of the glue with a substrate in stable.

Take the example that 900 micrometers, the narrowest width of the glue 30, the technology in the prior art made. To calculate with the most enlarged measure number 120% by the formula 900×5=(900-x)×(5+5×120%), x equals 490.9. In other words, the reduced width of the glue 30 is 490.9 micrometers. Compared with the LCD panel in the prior art, the LCD panel in the present invention reduces 54.5% of width of a glue at most.

The benefit of the present invention is that the LCD panel in the present invention reduces width of the glue effectively to achieve the design of narrow bezel of the LCD panel in an adhesion force assurance between the glue and a substrate by arranging a groove structure in a glue coating area on the substrate surface to increase a contact area between the glue and the substrate.

Those skilled in the art will readily observe that numerous modifications and alterations of the device may he made while retaining the teachings of the invention. Accordingly, the above disclosure should he construed as limited only by the metes and bounds of the appended claims.

What is claimed is:

1. An LCD panel, comprising:
a first substrate;
a second substrate. opposite to the first substrate;
a glue between the first substrate and the second substrate, for sticking the first substrate to the second substrate;
wherein a plurality of grooves arrange at intervals on at least one of two adjacent surfaces on the first substrate and the second substrate, and part of the glue, set up on the grooves, permeates the grooves.

2. The LCD panel of claim 1, wherein the glue spreads toward a first direction and a second direction perpendicular to the first direction, length of the glue in the first direction is longer than that of the glue in the second direction, and the grooves are arranged along with the first direction at intervals and extend along with the second direction.

3. The LCD panel of claim 1, wherein the grooves are disposed on both of the two adjacent surfaces.

4. The LCD panel of claim 3, wherein the first substrate comprises a first substrate body and a first surface layer on the first substrate body, the second substrate comprises a second substrate body and a second surface layer on the second substrate body, the first surface layer is set up with the second surface layer adjacently, and the grooves are arranged on the first surface layer and the second surface layer.

5. The LCD panel of claim 4, wherein depth of the grooves is equal to thickness of the first surface layer or that of the second surface layer.

6. The LCD panel of claim 4, wherein the first surface layer and the second surface layer comprise a transparent conductive layer.

7. The LCD panel of claim 4, wherein the LCD panel further comprises a conductive pad, locating in an area where the glue is, for electrically connecting the first substrate with the second substrate, and distance between centers of the two adjacent grooves is shorter than half of the interval distance between the conductive pad and the grooves.

8. The LCD panel of claim 7, wherein the distance is shorter or equal to 700 micrometers.

9. The LCD panel of claim 7, wherein a width of the grooves is longer or equal to 5 micrometers.

10. The LCD panel of claim 1, wherein a cross section of the grooves in the interval direction is isosceles trapezoid.

11. An LCD panel, comprising;
a first substrate;
a second substrate, opposite to the first substrate;
a glue between the first substrate and the second substrate, for sticking the first substrate to the second substrate, the glue spreading toward a first direction and a second direction perpendicular to the first direction, length of the glue in the first direction being longer than that of the glue in the second direction;
wherein a plurality of grooves are arranged at intervals on two adjacent surfaces on the first substrate and the second substrate, the grooves are arranged along with the first direction at intervals and extend along with the second direction, and part of the glue, set up on the grooves, permeates the grooves.

12. The LCD panel of claim 11, wherein the first substrate comprises a first substrate body and a first surface layer on the first substrate body, the second substrate comprises a second substrate body and a second surface layer on the second substrate body, the first surface layer is set up with the second surface layer adjacently, and the grooves are arranged on the first surface layer and the second surface layer.

13. The LCD panel of claim 12, wherein depth of the groove is equal to thickness of the first surface layer or that of the second surface layer.

14. The LCD panel of claim 12, wherein the first surface layer and the second surface layer comprise a transparent conductive layer.

15. The LCD panel of claim 12, wherein the LCD panel further comprises a conductive pad, locating in an area where the glue is, for electrically connecting the first substrate with the second substrate, and a distance between centers of the two adjacent grooves is shorter than half of the interval distance between the conductive pad and the grooves.

16. The LCD panel of claim 15, wherein the distance is shorter or equal to 700 micrometers.

17. The LCD panel of claim 15, wherein a width of the grooves is longer or equal to 5 micrometers.

18. The LCD panel of claim 1, wherein a cross section of the grooves in the interval direction is isosceles trapezoid.

19. An LCD panel, comprising:
a first substrate. comprising a first substrate body and a first surface layer on the first substrate body;
a second substrate. opposite to the first substrate, the second substrate comprising a second substrate body and a second surface layer on the second substrate body
a glue between the first substrate and the second substrate, the sticking the first substrate to the second substrate;
wherein the first surface layer is set up with the second surface layer adjacently, a plurality of grooves arrange at intervals on at least one of two adjacent surface on the first substrate and the second substrate, and part of the glue, set up on the grooves, permeates the grooves.

20. The LCD panel of claim 19, wherein the glue spreads toward a first direction and a second direction perpendicular to the first direction, length of the glue in the first direction is longer than that of the glue in the second direction, and the grooves are arranged along with the first direction at intervals and extend along with the second direction.
